(19) United States
(12) Patent Application Publication
(10) Pub. No.: US 2021/0094886 A1
(43) Pub. Date: Apr. 1, 2021

(54) METHOD FOR PRODUCING A CERAMIC ABSORBER, CERAMIC ABSORBER, AND USE OF SAME

(71) Applicant: Siemens Aktiengesellschaft, Munich (DE)

(72) Inventors: Christian Eigenbrod, Bremen (DE); Daniel Malangré, Bremen (DE); Hans-Christoph Ries, Bremen (DE); Thomas Grieb, Krefeld (DE); Holger Grote, Mülheim (DE); Stefan Werner Kiliani, Essen (DE); Claus Krusch, Essen (DE); Friederike Lange, Ratingen-Lintorf (DE); Christian Nikasch, Mülheim an der Ruhr (DE)

(73) Assignee: Siemens Aktiengesellschaft, Munich (DE)

(21) Appl. No.: 16/980,384

(22) PCT Filed: Mar. 12, 2019
(86) PCT No.: PCT/EP2019/056118

§ 371 Date: Sep. 12, 2020

(30) Foreign Application Priority Data
Mar. 16, 2018 (DE) 10 2018 106 260.5

(51) Int. Cl. C04B 38/10; C04B 35/185; C04B 35/10; C04B 35/64; C04B 38/00; G10K 11/162; B28B 1/26; B28B 11/24

(52) U.S. Cl. CPC C04B 38/10; C04B 35/185; C04B 35/10; C04B 35/64; C04B 38/0058; C04B 38/0054; C04B 2235/77; B28B 1/26; B28B 11/243; C04B 2235/3463; C04B 2235/3217; C04B 2235/6567; G10K 11/162

(57) ABSTRACT

A ceramic absorber for damping, in particular absorbing, vibrations, in particular combustion vibrations, preferably in gas turbines, which has a foam structure. For the ceramic absorber, the sound absorption capacity is set in a defined way and the efficiency is improved. The foam structure is based on a ceramic powder which contains either a component from the class of silicates or a component from the class of oxides, or a combination of a component from the class of silicates and a component from the class of oxides, and the foam structure has a homogeneous pore distribution.

### CROSS REFERENCE TO RELATED APPLICATIONS

This application is the US National Stage of International Application No. PCT/EP2019/056118 filed 12 Mar. 2019, and claims the benefit thereof. The International Application claims the benefit of German Application No. DE 10 2018 106 260.5 filed 16 Mar. 2018. All of the applications are incorporated by reference herein in their entirety.

### FIELD OF INVENTION

The invention relates to a process for producing a ceramic absorber, in which a ceramic powder is provided, a slip is produced and the slip is foamed to generate a foam. The invention further relates to a ceramic absorber for damping, especially for absorption, of vibrations, especially combustion vibrations, preferably in gas turbines, with a foam structure. A further aspect of the invention relates to the use of a ceramic absorber.

### BACKGROUND OF INVENTION

Vibrations in the context of the invention are understood to mean pressure fluctuations in the form of sound waves, especially combustion vibrations, in gas turbines. The combustion of a gaseous preliminary mixture, at equivalence ratios close to the lean ignition limit, has a tendency to result in combustion-induced instabilities. If the ever-present acoustic excitation of a possible instability in the combustion system exceeds the inner damping, the system begins to resonate. The combustion that causes the resonance subsequently becomes the amplifier thereof. In this case, the associated vibrations, without a further increase in power, can be resonantly amplified to considerable values and damage the gas turbine. There is therefore a need to attenuate such thermoacoustic instabilities in gas turbines.

An absorber is intended to damp the acoustic waves that arise in this manner. At the same time, the absorber must be able to withstand the conditions of a gas turbine in a lasting manner since the damping in the combustion chamber of the gas turbine has to be effected at high temperature and high pressure. The continuing rise in combustion temperatures is placing new challenges on the material of an absorber.

A ceramic sound absorber is known, for example, from DE 697 36 104 T2. The ceramic sound absorber described therein consists of a ceramic material based on alumina, containing silicon carbide (SiC) filament crystals. The ceramic sound absorber is designed as a porous ceramic body. Pores close to the front side of the ceramic body have an average diameter in the range from fifty to four hundred and fifty micrometers, with increasing pore diameter in the direction of the back side of the ceramic body to an average diameter in the range from five hundred to three thousand four hundred micrometers. The front side of the porous ceramic body is characterized by a denser layer having pores within a range from ten micrometers to fifty micrometers.

However, known porous ceramic structures having sound-reducing properties do not meet the necessary demands for adequate sound reduction either with regard to the damping or with regard to the frequency range to be absorbed. Therefore, known Helmholtz resonators are typically used.

A disadvantage here, however, is that the metallic Helmholtz resonators known to date have to be purged with cooling air in a complex manner in order to assure adequate cooling of the metal. To increase the efficiency, however, it is necessary for the amount of cooling air to be reduced. A further disadvantage arises from the fact that Helmholtz resonators have only narrowband absorption. Therefore, many different narrowband Helmholtz resonators have to be used to damp all relevant frequencies.

Likewise known is the use of flow-through Helmholtz resonators. These have broader-band operation, but with low efficiency.

Additionally known is the use of controlled valves that periodically connect a small additional gas mass flow. The switching frequency is matched here to the frequency of the resonance that occurs in a closed control circuit with sensors that recognize the intensity that occurs and measure its frequency, with rotation of the phase position by 180 degrees for damping of the vibration. However, the use of these controlled valves is likewise associated with low efficiency.

### SUMMARY OF INVENTION

It is therefore an object of the invention to develop a process of the type specified at the outset for producing a ceramic absorber and a ceramic absorber of the type specified at the outset in such a way that the sound absorption capacity of the absorber is adjustable in a defined manner and the efficiency can be improved.

The object underlying the invention is achieved in the case of a process for producing a ceramic absorber in that the ceramic powder is provided using exclusively at least one component from the class of the silicates, exclusively one or more components from the class of the oxides, or a combination of at least one component from the class of the silicates and at least one component from the class of the oxides, and in that a homogeneous pore distribution is generated in the foam structure. In the case of a ceramic absorber of the type specified at the outset, the object underlying the invention is achieved in that the foam structure is based on a ceramic powder, having a component from the class of the oxides, or a component from the class of the silicates, or a combination of a component from the class of the silicates and a component from the class of the oxides, wherein the foam structure has a homogeneous pore distribution.

In production of a ceramic absorber, the ceramic powder may consist exclusively of silicate, exclusively of oxide, or of a material combination containing at least one component from the class of the silicates and at least one component from the class of the oxides. Each of these options gives an end product suitable for the end use, but individual parameters may be matched individually via the adjusted choice of material or of the proportion by weight of the components in the material combination. More particularly, in the case of use of two or more components from the class of the oxides, these may differ from one another in terms of their particle sizes. More particularly, the ceramic powder may be free of silicon carbide. For production of the slip, the ceramic powder may be added to a dispersion medium. In addition, additives added to the slip may be dispersants, foam formers and optionally binders.

The pore structure of the absorber enables destructive interference and dissipation of the propagating soundwaves. Pore absorbers damp a broad frequency range and thus offer the advantage of significantly broader-band absorption than the metallic resonators used to date which, as Helmholtz resonators, only have very narrowband absorption. The flow resistance, i.e. the flow resistance of the porous ceramic foam, is directly correlated to its porosity. The initial foam density can be used to control the flow resistance, such that good absorption is achieved in predetermined frequency ranges.

Compared to metallic structures, the ceramic absorbers have elevated corrosion resistance and elevated thermal stability. Moreover, the sound-absorbing foam ceramics have very low thermal conductivity, which means that they are also of good suitability as thermal insulators. A further advantage over metallic structures is that ceramic materials do not require cooling. Stabilization of combustion is thus possible without performance-reducing cooling of resonators. At the same time, efficiency can be enhanced by dispensing with cooling air.

In one development of the process, the ceramic powder is provided with a proportion of the component or components from the class of the silicates within a range from fifty percent by weight to sixty percent by weight and, correspondingly, a proportion of the component or components from the class of the oxides within a range from forty percent by weight to fifty percent by weight. The use of such a material composition, coupled with a defined pore distribution, can advantageously result in very good thermal shock resistance.

In one development of the process, the silicates and/or the oxides have different particle sizes when more than one component is used. The mass ratio of a component having coarser particles to a component having finer particles is sixty to eighty percent by mass to, correspondingly, forty to twenty percent by mass, especially a mass ratio of seventy percent by mass to thirty percent by mass. In particular, there may be such a mass ratio of components having finer particles to components having coarser particles when the ceramic powder consists exclusively of oxide. More particularly, both components from the class of the oxides may be alumina and have different particle sizes. More particularly, the coarser-grain component used may be alumina with particle sizes of less than forty-five micrometers, and the finer-grain component used may be alumina having particle sizes within a range from 0.5 micrometer to 0.8 micrometer.

Alternatively, the mass ratio of a component having coarser particles to a component having finer particles may be fifty to seventy percent by mass to, correspondingly, fifty to thirty percent by mass, especially a mass ratio of sixty percent by mass to forty percent by mass. More particularly, such a mass ratio of components having finer particles to components having coarser particles may exist when the ceramic powder consists of a material combination containing one component from the class of the silicates and at least two components from the class of the oxides. More particularly, both components from the class of the oxides may be alumina and have different particle sizes. More particularly, the coarser-grain component used may be alumina having particle sizes of less than forty-five micrometers, and the finer-grain component used may be alumina having particle sizes within a range from 0.5 micrometer to 0.8 micrometer.

In one development of the process, mullite is used from the class of the silicates. Mullite has high thermal stability. More particularly, it is possible to use fused mullite from the class of the silicates. It is possible with preference to use the fused mullite Alodur WFM (white fused mullite) from the manufacturer Treibacher. More preferably, the mullite may have particle sizes of forty micrometers. From the class of the oxides, alumina is used. Alumina has high thermal stability. More particularly, it is possible to use coarse-grain alumina. It is possible with preference to use the coarse-grain alumina Tabular Alumina T60, Li from the manufacturer Almatis. More preferably, the coarse-grain alumina may have particle sizes of less than forty-five micrometers. It is further possible to use fine-grain alumina. It is possible with preference to use the fine-grain alumina CT-3000 SG from the manufacturer Alcoa. More preferably, the fine-grain alumina may have particle sizes within a range from 0.5 micrometer to 0.8 micrometer and/or spherical particles.

In one development of the process, the ceramic powder, dispersant and foam former are added to a dispersion medium for production of the slip. Optionally, in the case of use of a ceramic powder containing at least one component, preferably two or more components, exclusively from the class of the oxides, binder may be added to the slip. In one development of the process, the slip comprising the ceramic powder comprising a component from the class of the silicates or a combination of a component from the class of the silicates and at least one component from the class of the oxides is produced based on silica sol. In an alternative development of the process, the slip comprising the ceramic powder comprising components, especially exclusively from the class of the oxides, is produced based on water.

In one development of the process, the dispersant used is an organic and/or alkali-free dispersant. More particularly, the dispersant used is a dispersant based on carboxylic acid. The dispersant used may preferably be the dispersant Dolapix CE 64, from the manufacturer Zschimmer & Schwartz. The addition of a dispersant can enable or stabilize the dispersing of at least two phases.

In one development of the process, the foam former used is an anion-active surfactant. More particularly, the foam former used is a surfactant based on fatty alcohol sulfate. The foam former used may preferably be the foaming agent W53 from the manufacturer Zschimmer & Schwartz. As a result of the addition of a foam former, the slip can be foamed. Foaming to different volumes can generate foams of different density. More particularly, the slip is foamed by means of a stirrer. It may be the case that denser layers are additionally applied to the outer surfaces.

The foam can be solidified by self-consolidation if the foamed slip has been produced based on silica sol. Alternatively, the foam can be solidified by means of a hydratable binder if the foamed slip has been produced based on water.

In one development of the process, binder is added to the ceramic powder produced that comprises at least one component, preferably two or more components, exclusively from the class of the oxides. The binder serves for solidification/consolidation of the foam if the foam has been produced based on water. The binder may be added to the slip directly prior to beating of the slip. More particularly, the binder used is alumina. The binder used may be hydratable alumina. The binder used may preferably be the alumina Alphabond 300 from the manufacturer Almatis. More particularly, fifty percent of the particles of the Alphabond 300 alumina from the manufacturer Almatis are smaller than four to eight micrometers (D50: 4 μm to 8 μm).

In one development of the process, the foam, for shaping and/or for solidification, is introduced into a preferably nonabsorptive mold, especially with a smooth surface. The fresh casting formed in this way can remain in the mold until it has sufficient strength for demolding. Owing to the smooth surface, the casting can be readily parted from the mold. More particularly, the solidification can be effected by self-consolidation.

In one development of the process, the foam is sintered. For this purpose, the foam is heated up to a maximum temperature and then cooled down again. The sintering is effected at a maximum temperature within a range from 1500° C. to 1750° C. The sintering is preferably effected at a maximum temperature within a range from 1600° C. to 1750° C. More preferably, the sintering is effected at a maximum temperature of 1700° C. In the course of sintering, the solidified foam can be heated to high temperatures. These temperatures are below the melting temperature of the respective components. In this way, the shape of the foam is maintained in the course of sintering. The choice of maximum sintering temperatures defines the upper limit for the later use temperature. If sintering is effected, for example, at a maximum temperature of 1700° C., the workpiece produced in this way is utilizable for use in ambient temperatures up to 1700° C.

In one development of the process, the sintering is effected at the maximum temperature over a period of time within a range from sixty minutes to one hundred and eighty minutes. The sintering is preferably effected at the maximum temperature over a period of time within a range from ninety minutes to one hundred and fifty minutes. The sintering is particularly preferably effected at the maximum temperature over a period of time of one hundred and twenty minutes. Overall, for the heating, holding at the maximum temperature and subsequent cooling, a period of time of nearly twenty-four hours is used.

According to the invention, the ceramic absorber has a foam structure based on a ceramic powder, having a component from the class of the silicates, a component from the class of the oxides, or a combination of a component from the class of the silicates and a component from the class of the oxides, wherein the foam structure has a homogeneous pore distribution.

In an advantageous development, the silicate is mullite and/or the oxide is alumina. Both mullite and alumina have high thermal stability. The combination of mullite and alumina in particular may provide a material combination having high thermal shock resistance.

In one development, the proportion of the component from the class of the silicates is within a range from fifty percent by weight to sixty percent by weight, and the proportion of the component from the class of the oxides is correspondingly within a range from forty percent by weight to fifty percent by weight. Such a material composition, especially the combination of mullite and alumina, coupled with the pore distribution, advantageously results in very good thermal shock resistance. The material properties such as modulus of elasticity, coefficient of thermal expansion or thermal conductivity may be varied and/or adjusted in accordance with the specific requirements via the composition chosen.

In one development, the foam structure is an open-pore structure, especially on all outer surfaces. The type of open porosity can define the flow resistance. The foam structure preferably has a porosity within a range from sixty percent to ninety percent and/or an area porosity of seventy percent to eighty percent. Owing to the high porosity of the sound-absorbing foam ceramic, it can be reprocessed in a very simple manner. More particularly, the porosity of the ceramic foam can be determined by the level of foam density, since the volume of air introduced into the foam and the porosity of the sintered ceramic body correlate with one another. The pore distribution may be homogeneous throughout the ceramic absorber. Denser layers on the outer surfaces may be provided.

In an advantageous development, the pores take the form of spherical pores and/or matrix pores. The spherical pores preferably have a diameter within a range from sixty micrometers to six hundred micrometers. In particular, the spherical pores have a diameter within a range from seventy micrometers to three hundred micrometers. The matrix pores preferably have a pore size of less than thirty micrometers. In particular, the matrix pores have a pore size of less than ten micrometers. The pore geometry and pore size can define the flow resistance.

In one development, the spherical pores have pore windows. The diameter of the pore windows is preferably within a range from forty micrometers to sixty micrometers. In particular, the diameter of the pore windows is fifty micrometers. The size of the pore windows can define the flow resistance.

In an advantageous development, the ceramic absorber has a density within a range from 0.55 g/cm³ to 0.70 g/cm³. More particularly, the density can be adjusted via the foam structure, especially the open-pore foam structure. The density may advantageously be homogeneous over the entire ceramic absorber.

In an advantageous development, the ceramic absorber has a sound-absorbing action within a frequency range from twenty hertz to twenty kilohertz. This frequency range encompasses the frequencies of combustion vibrations, for example in a gas turbine, and can therefore be used for damping of such combustion vibrations, preferably in gas turbines.

In an advantageous development, the ceramic absorber has a flow resistance within a range from 10 kPa/m² to 3000 kPa/m². The ceramic body preferably has a flow resistance within a range from 50 kPa/m² to 100 kPa/m². The determination of the specific flow resistance enables the calculation of the sound absorptivity. The flow resistance can be controlled via the initial foam density, such that good absorption in particular frequency ranges is achievable.

A ceramic absorber is used in gas turbines, blast furnaces, catalytic converters, pore burners or aircraft engines. The aforementioned ceramic absorber is preferably used in gas turbines, blast furnaces, catalytic converters, pore burners or aircraft engines. The ceramic absorber has preferably been produced by the process described above.

### BRIEF DESCRIPTION OF THE DRAWINGS

The process for producing a ceramic absorber is elucidated hereinafter with reference to the FIGURE. The FIGURE shows:

FIG. 1 a flow diagram of the progression of a process for producing a ceramic absorber.

### DETAILED DESCRIPTION OF INVENTION

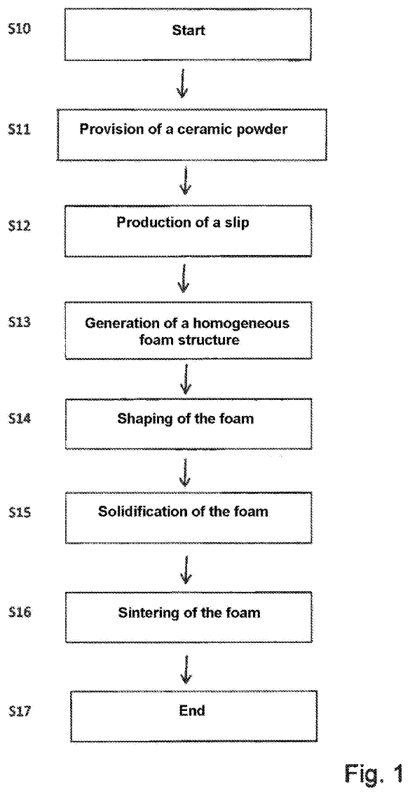

FIG. 1 shows a flow diagram of the progression of a process for producing a ceramic absorber. Process step S10 indicates the start of the process, process step S17 the end of the process.

In process step S11, a ceramic powder is provided. More particularly, the ratio of various components in the ceramic powder relative to one another is adjusted if the ceramic powder consists of more than one component.

There follows a description by way of example of the progression of the process for production of a ceramic absorber in which the ceramic powder consists of a material combination:

For production of a ceramic powder consisting of a material combination of silicate and oxide, in process step S11, one component from the class of the silicates and two components from the class of the oxides are combined. In the working example, the silicate used is mullite. More particularly, the fused mullite Alodur WFM (white fused mullite) from the manufacturer Treibacher is used, which has particle sizes of forty micrometers. From the class of the oxides, alumina is used. More particularly, both components are from the class of oxides of alumina. The aluminas used here are coarse-grain alumina and fine-grain alumina. The coarse-grain alumina used is the alumina Tabular Alumina T60, Li from the manufacturer Almatis, with particle sizes of less than forty-five micrometers. The fine-grain alumina used is the alumina CT-3000 SG from the manufacturer Alcoa, with particle sizes within a range from 0.5 micrometer to 0.8 micrometer and spherical particles. The ratio of alumina having coarser particles to alumina having finer particles is sixty percent by mass to forty percent by mass. The proportion of mullite and alumina in the working example is fifty percent by weight in each case. A different ratio of mullite to alumina may be provided. The ceramic powder may have a proportion of mullite within a range from fifty percent by weight to sixty percent by weight and a proportion of alumina within a range from forty percent by weight to fifty percent by weight.

In process step S12, a slip is produced. The dispersion medium used is silica sol. Silica sol is an aqueous colloidal suspension of silicon dioxide. In the working example, silica sol having thirty percent silicon dioxide and having a primary colloid size of eight nanometers is used. The ceramic powder and a dispersant are added to the silica sol. The dispersion is effected by means of addition of the dispersant. The dispersant used in the working example is the dispersant Dolapix CE 64, from Zschimmer & Schwartz.

In process step S13, the slip is foamed. A homogeneous pore distribution is generated in the foam structure. For this purpose, a foam former is first added to the slip. The foam former used in the working example is the foaming agent W53 from the manufacturer Zschimmer & Schwartz. After the foam former has been added, the slip is foamed with a stirrer. The foaming to different volumes enables generation of foams of different density. The foam density generated is within a range from 0.4 g/cm³ to 1.5 g/cm³. Owing to the very good foam stability, a homogeneous foam is formed.

In process step S14, the foam is shaped. For this purpose, the freshly foamed foam is poured into a nonabsorptive mold. More particularly, the nonabsorptive mold has a smooth inner wall. The fresh casting formed in this way remains in the mold until it has sufficient strength for demolding by virtue of self-consolidation.

In process step S15, the foam is solidified by means of self-consolidation. The self-consolidation is effected through agglomeration or through precipitation of the sol, on account of a drop in the pH resulting from the hydration of alumina particles. In this way, the moist ceramic foam solidifies of its own accord. Subsequently, the consolidated foam is dried stepwise.

In process step S16, the foam is sintered. In the working example, the sintering is effected at a temperature of 1700° C. and over a period of time of 2 hours. Sintering at a different temperature and/or over a different period of time may be envisaged. Shrinkage occurs in the course of sintering. The adjustment of the foam densities determines the porosity of the ceramic foam after sintering since the volume of air introduced and the porosity of the sintered ceramic correlate with one another. After the sintering, the ceramic body has a density within a range from 0.55 g/cm³ to 0.70 g/cm³.

There follows a description, likewise by way of example, of the progression of the process for producing a ceramic absorber, in which the ceramic powder consists either of silicate or of oxide:

For production of a ceramic powder consisting exclusively of silicate, the ceramic powder used in step S11 is mullite. More particularly, fused mullite Alodur WFM (white fused mullite) from the manufacturer Treibacher is used, which has particle sizes of forty micrometers. The further process steps S12 to S16 correspond to the process steps described above.

For production of a ceramic powder consisting exclusively of oxide, in process step S11, two components from the class of the oxides are combined. The oxide used in the working example is alumina. More particularly, both components from the class of the oxides are alumina. Both course-grain alumina and fine-grain alumina are used. The course-grain alumina used is the alumina Tabular Alumina T60, Li from the manufacturer Almatis, with particle sizes of less than forty-five micrometers. The fine-grain alumina used is the alumina CT-3000 SG from the manufacturer Alcoa, with particle sizes within a range from 0.5 micrometer to 0.8 micrometer and spherical particles. The ratio of alumina having coarser particles to alumina having finer particles is seventy percent by mass to thirty percent by mass.

In process step S12, a slip is produced based on water. The slip contains the ceramic powder consisting exclusively of oxide and a dispersant. The dispersion is effected by means of addition of the dispersant. The dispersant used in the working example is the dispersant Dolapix CE 64, from the manufacturer Zschimmer & Schwartz. Prior to the foaming of the slip that follows in process step S13, a binder for the subsequent consolidation is additionally supplied to the suspension.

In process step S13, the slip is foamed. A homogeneous pore distribution in the foam structure is generated. For this purpose, a foam former is first added to the slip. The foam former used in the working example is the foaming agent W53, from the manufacturer Zschimmer & Schwartz. Subsequently, the slip is foamed to completion with a stirrer. The foaming to different volumes enables generation of foams of different density. The foam density generated is within a range from 0.75 g/cm³ to 0.9 g/cm³.

In process step S14, the foam is shaped. For this purpose, the freshly foamed foam is poured into nonabsorptive molds. More particularly, the nonabsorptive molds have a smooth inner wall. The fresh casting formed in this way remains in the mold until it has sufficient strength for demolding by virtue of consolidation.

In process step S15, the foam is solidified by means of consolidation. The consolidation is effected by means of hydration of the binder added in process step S12. In this way, the moist ceramic foam solidifies of its own accord. Subsequently, the consolidated foam is dried stepwise.

In process step S16, the foam is sintered. In the working example, the sintering is effected at a temperature of 1700° C. and over a period of time of two hours. Sintering at a different temperature and/or over a different period of time may be envisaged. Shrinkage occurs in the course of sintering. The adjustment of the foam densities determines the porosity of the ceramic foam after sintering since the volume of air introduced and the porosity of the sintered ceramic correlate with one another. After the sintering, the ceramic body has a density within a range from 0.55 g/cm³ to 0.70 g/cm³.

1.-22. (canceled)

23. A process for producing a ceramic absorber, comprising:
providing a ceramic powder,
producing a slip and wherein the slip is foamed to generate a foam and a homogeneous pore distribution in the foam structure is generated,
wherein the ceramic powder is provided using a combination of at least one component from the class of the silicates and at least one component from the class of the oxides,
wherein the ceramic powder is provided with a proportion of the component or components from the class of the silicates within a range from fifty percent by weight to sixty percent by weight and,
wherein, correspondingly, a proportion of the component or components from the class of the oxides within a range from forty percent by weight to fifty percent by weight.

24. The process as claimed in claim 23,
wherein the silicates and/or the oxides have different particle sizes when more than one component is used, where the mass ratio of a component having coarser particles to a component having finer particles is sixty to eighty percent by mass to, correspondingly, forty to twenty percent by mass,
especially a mass ratio of seventy percent by mass to thirty percent by mass, or a mass ratio of fifty to seventy percent by mass to, correspondingly, fifty to thirty percent by mass,
especially a mass ratio of sixty percent by mass to forty percent by mass.

25. The process as claimed in claim 23,
wherein mullite is used from the class of the silicates and/or alumina from the class of the oxides.

26. The process as claimed in claim 23,
wherein the slip is produced by adding the ceramic powder, dispersant and foam former to a dispersion medium.

27. The process as claimed in claim 23,
wherein the slip comprising the ceramic powder comprising a component from the class of the silicates or a combination of a component from the class of the silicates and at least one component from the class of the oxides is produced based on silica sol, or
wherein the slip comprising the ceramic powder comprising components, especially exclusively from the class of the oxides, is produced based on water.

28. The process as claimed in claim 23,
wherein the dispersant used is an organic and/or alkali-free medium, and/or based on carboxylic acid.

29. The process as claimed in claim 23,
wherein the foam former used is an anion-active surfactant, and/or based on fatty alcohol sulfate.

30. The process as claimed in claim 23,
wherein the slip is foamed by means of a stirrer.

31. The process as claimed in claim 23,
wherein binder, especially alumina, is added to the ceramic powder produced that comprises at least one, preferably two or more, components, exclusively from the class of the oxides.

32. The process as claimed in claim 23,
wherein the foam, for shaping and/or for solidification, is introduced into a nonabsorptive mold, and/or a mold with a smooth surface.

33. The process as claimed in claim 23,
wherein the foam is sintered,
wherein the sintering is effected at a temperature in a range from 1500° C. to 1750° C., preferably 1600° C. to 1750° C., more preferably at a temperature of 1700° C., and/or
over a period of time within a range from sixty minutes to one hundred and eighty minutes, preferably ninety minutes to one hundred and fifty minutes, more preferably over a period of time of one hundred and twenty minutes.

34. A ceramic absorber for damping or absorption of vibrations and/or combustion vibrations, comprising:
a foam structure based on a ceramic powder, having a combination of a component from the class of the silicates and a component from the class of the oxides, wherein the foam structure has a homogeneous pore distribution;
wherein the proportion of the component from the class of the silicates is within a range from fifty percent by weight to sixty percent by weight, and
wherein the proportion of the component from the class of the oxides is correspondingly within a range from forty percent by weight to fifty percent by weight.

35. The ceramic absorber as claimed in claim 34,
wherein the silicate is mullite and/or the oxide is alumina.

36. The ceramic absorber as claimed in claim 34,
wherein the foam structure is an open-pore structure, especially on all outer surfaces, preferably with a porosity within a range from sixty percent to ninety percent and/or an area porosity of seventy percent to eighty percent.

37. The ceramic absorber as claimed in claim 36,
wherein the pores take the form of spherical pores and/or matrix pores,
wherein the spherical pores preferably have a diameter within a range from sixty micrometers to six hundred micrometers, especially within a range from sixty micrometers to three hundred micrometers, and/or the matrix pores preferably have a pore size of less than thirty micrometers, especially less than ten micrometers.

38. The ceramic absorber as claimed in claim 37,
wherein the spherical pores have pore windows,
wherein the diameter of the pore windows is preferably within a range from forty micrometers to sixty micrometers, especially fifty micrometers.

39. The ceramic absorber as claimed in claim 34,
wherein a density within a range from 0.55 g/cm³ to 0.70 g/cm³.

40. The ceramic absorber as claimed in claim 34,
wherein a sound-absorbing action within a frequency range from twenty hertz to twenty kilohertz.

41. The ceramic absorber as claimed in claim 34,
wherein a flow resistance within a range from 10 kPa/m² to 3000 kPa/m², preferably within a range from 50 kPa/m² to 100 kPa/m².
